(19) United States
(12) Patent Application Publication
(10) Pub. No.: US 2014/0256376 A1
(43) Pub. Date: Sep. 11, 2014

(54) WIRELESS DEVICE WITH BUILT-IN SELF TEST (BIST) CAPABILITY FOR TRANSMIT AND RECEIVE CIRCUITS

(71) Applicant: QUALCOMM INCORPORATED, San Diego, CA (US)

(72) Inventors: Haim Mendel Weissman, Haifa (IL); Avigdor Brillant, Zichron Ya'akov (IL); Lior Raviv, Atlit (IL); Mohammad Ali Tassoudji, San Diego, CA (US); Yu-Chin Ou, San Diego, CA (US); Mazhareddin Taghivand, Campbell, CA (US)

(73) Assignee: QUALCOMM Incorporated, San Diego, CA (US)

(21) Appl. No.: 13/875,083

(22) Filed: May 1, 2013

Related U.S. Application Data
(60) Provisional application No. 61/776,477, filed on Mar. 11, 2013.

(51) Int. Cl. H04B 17/00

(52) U.S. Cl. CPC H04B 17/00
USPC 455/550.1

(57) ABSTRACT

A wireless device with built-in self test (BIST) capability for testing/calibrating transmit and receive circuits is disclosed. In an exemplary design, an apparatus (e.g., a wireless device or an integrated circuit) includes a first circuit and a second circuit. The first circuit (e.g., a transmitter or a mixer) provides a test signal to at least one transmit path. The test signal is electro-magnetically coupled from the output of the at least one transmit path to a test signal line. For example, the test signal may be provided from the at least one transmit path via at least one antenna feed line to at least one antenna element and may be electro-magnetically coupled from the at least one antenna feed line to the test signal line. The second circuit (e.g., a buffer, a receiver, or a mixer) processes a received test signal from the test signal line.

### I. CLAIM OF PRIORITY UNDER 35 U.S.C. §119

The present application for patent claims priority to Provisional U.S. Application Ser. No. 61/776,477, entitled “WIRELESS DEVICE WITH BUILT-IN SELF TEST (BIST) CAPABILITY FOR TRANSMIT AND RECEIVE CIRCUITS,” filed Mar. 11, 2013, assigned to the assignee hereof, and expressly incorporated herein by reference.

### BACKGROUND

I. Field

The present disclosure relates generally to electronics, and more specifically to a wireless device.

II. Background

A wireless device (e.g., a cellular phone or a smartphone) may include a transmitter and a receiver coupled to an antenna to support two-way communication. For data transmission, the transmitter may modulate a local oscillator (LO) signal with data to obtain a modulated signal, amplify the modulated signal to obtain an output radio frequency (RF) signal having the proper transmit power level, and transmit the output RF signal via the antenna to a base station. For data reception, the receiver may obtain a received RF signal via the antenna and may condition and process the received RF signal to recover data sent by the base station.

A wireless device may include a number of antenna elements and associated transmit and receive circuits to support data transmission and reception. The transmit and receive circuits may be designed to meet specifications but may have performance that can vary widely due to variations in manufacturing, temperature, power supply voltage, etc. It may be desirable to test/calibrate the transmit and/or receive circuits in order to ensure good performance even in the presence of these variations.

### BRIEF DESCRIPTION OF THE DRAWINGS

FIG. 1 shows a wireless device communicating with different wireless systems.

FIG. 2 shows a wireless device with BIST capability.

FIG. 3 shows a block diagram of a transceiver within the wireless device in FIG. 2.

FIG. 4 shows a schematic diagram of a front-end of the transceiver in FIG. 2.

FIG. 5 shows a schematic diagram of a back-end of the transceiver in FIG. 2.

FIG. 6A shows a transmit (TX) BIST configuration for the front-end in FIG. 4.

FIG. 6B shows a receive (RX) BIST configuration for the front-end in FIG. 4.

FIG. 6C shows a TX-RX loop-back BIST configuration.

FIGS. 7A to 7C show three exemplary designs of a front-end with BIST capability.

FIG. 8 shows a process for testing TX circuits with BIST.

FIG. 9 shows a process for testing RX circuits with BIST.

### DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for the purpose of providing a thorough understanding of the exemplary designs of the present disclosure. It will be apparent to those skilled in the art that the exemplary designs described herein may be practiced without these specific details. In some instances, well-known structures and devices are shown in block diagram form in order to avoid obscuring the novelty of the exemplary designs presented herein.

A wireless device with built-in self test (BIST) capability for testing/calibrating transmit and receive circuits is disclosed herein. The wireless device may be any electronics device supporting wireless communication.

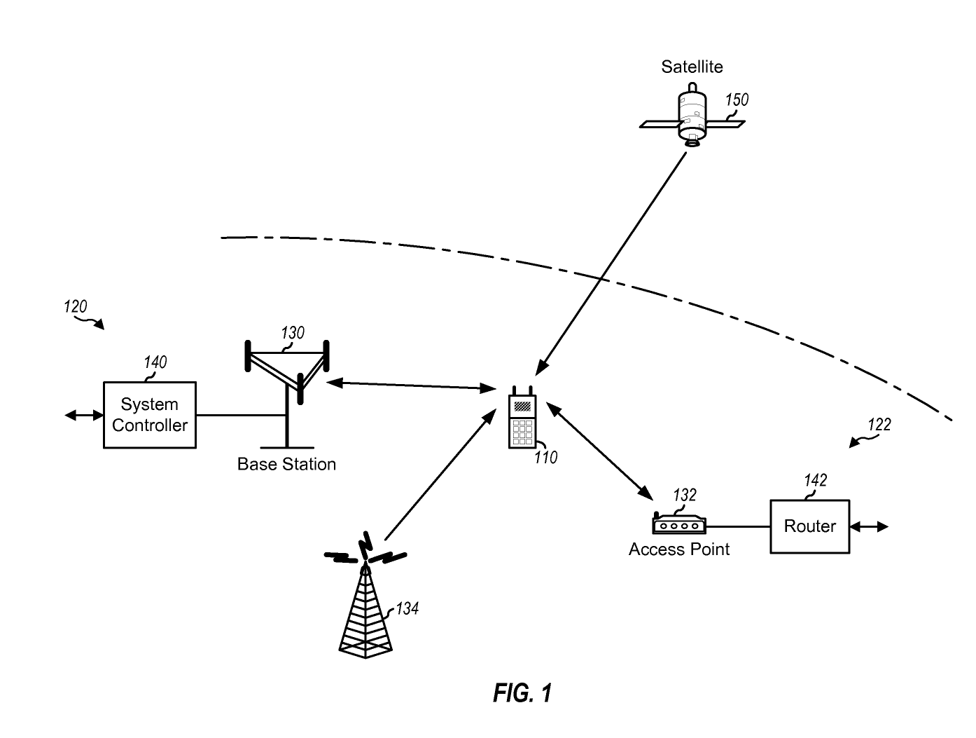

FIG. 1 shows a wireless device 110 capable of communicating with different wireless communication systems 120 and 122. Wireless system 120 may be a Long Term Evolution (LTE) system, a Code Division Multiple Access (CDMA) system, a Global System for Mobile Communications (GSM) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA. Wireless system 122 may be a wireless local area network (WLAN) system, which may implement IEEE 802.11, Hiperlan, etc. For simplicity, FIG. 1 shows wireless system 120 including one base station 130 and one system controller 140, and wireless system 122 including one access point 132 and one router 142. In general, each wireless system may include any number of stations and any set of network entities.

Wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless system 120 and/or 122. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1x, EVDO, TD-SCDMA, GSM, IEEE 802.11, etc.

Wireless device 110 may support operation at a very high frequency, e.g., within millimeter (mm)-wave frequencies from 40 to 300 gigahertz (GHz). For example, wireless device 110 may operate at 60 GHz for IEEE 802.11ad. Wireless device 110 may include an antenna system to support operation at mm-wave frequency. The antenna system may include a number of antenna elements, with each antenna element being used to transmit and/or receive RF signals. The terms “antenna” and “antenna element” may be used interchangeably. An antenna element may be implemented with a patch antenna, a dipole antenna, or an antenna of some other type. A suitable antenna type may be selected for use based on the operating frequency of the wireless device, the desired performance, etc. In an exemplary design, an antenna system may include a number of patch antennas supporting operation at mm-wave frequency.

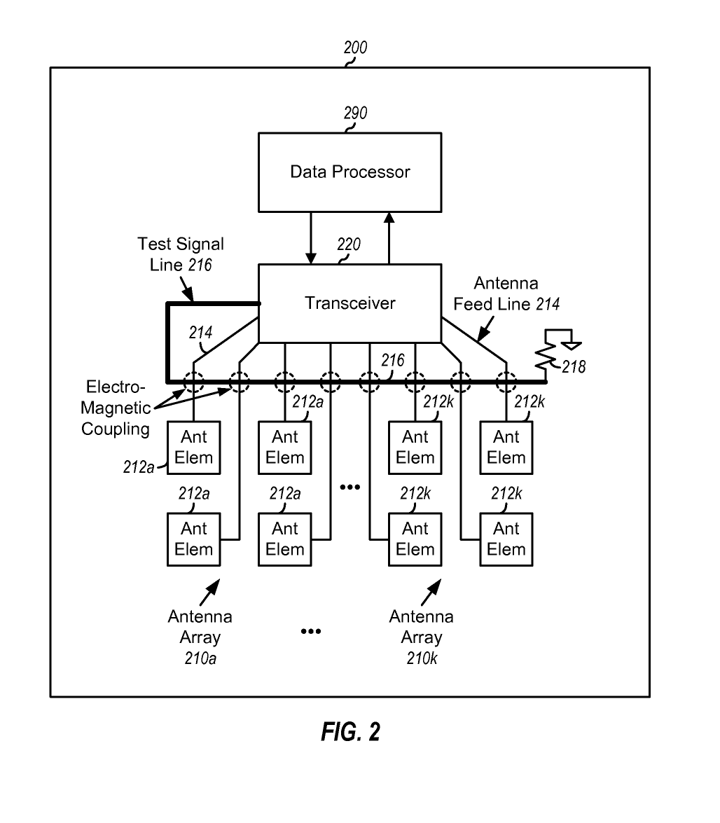

FIG. 2 shows an exemplary design of a wireless device 200 with TX and RX BIST capability. Wireless device 200 may be one exemplary design of wireless device 110 in FIG. 1. Wireless device 200 includes K antenna arrays 210a to 210k, where K may be one or greater. Antenna array 210a includes antenna elements 212a, and antenna array 210k includes antenna elements 212k.

FIG. 2 shows a top view of an exemplary layout of antenna arrays 210a to 210k. Each antenna array 210 includes one or more antenna elements 212, which may be arranged in an M×N grid, where M and N may each be any integer value. For example, an antenna array may include four antenna elements arranged in a 2×2 grid (as shown in FIG. 2), or eight antenna elements arranged in a 2×4 grid, etc. The K antenna arrays 210a to 210k may include the same number of antenna elements (as shown in FIG. 2) or different numbers of antenna elements 212.

Antenna elements 212 may each be a patch antenna (as shown in FIG. 2) or an antenna of some other type. A patch antenna may be implemented with a conductive patch or structure of any suitable size, which may be selected based on a target operating frequency (e.g., 60 GHz) of wireless device 200. A patch antenna may also be implemented with a conductive patch or structure of any suitable shape, which may be selected to obtain a desired antenna beam pattern.

In an exemplary design shown in FIG. 2, antenna elements 212a to 212k of antenna arrays 210a to 210k may have similar size and shape. In this exemplary design, antenna elements 212a to 212k of the K antenna arrays 210a to 210k may have similar antenna beams and similar operating frequencies. In another exemplary design, antenna elements 212a to 212k of different antenna arrays 210a to 210k may have different sizes and/or shapes and may then have different antenna beam patterns and/or different operating frequencies.

Wireless device 200 includes a transceiver 220 that (i) generates transmit RF signals for transmission via antenna elements 212 and (ii) processes received RF signals from antenna elements 212. Transceiver 220 is coupled to all antenna elements 212a to 212k of antenna arrays 210a to 210k via antenna feed lines 214. Transceiver 220 is also coupled to a test signal line 216. Antenna feed lines 214 and test signal line 216 may be implemented and routed in a manner to obtain a desired amount of electro-magnetic coupling between antenna feed lines 214 and test signal line 216. In an exemplary design, antenna feed lines 214 may be formed on an integrated circuit (IC) chip and test signal line 216 may be formed external to the IC chip. In another exemplary design, antenna feed lines 214 may be formed on a first metal layer (e.g., on an IC chip or a printed circuit board (PCB)) and test signal line 216 may be formed on a second metal layer (e.g., directly beneath or above the first metal layer on the IC chip or PCB).

Wireless device 200 also includes a data processor 290 coupled to transceiver 220. Data processor 290 may perform various functions for wireless device 200. For example, data processor 290 may process data being transmitted via transceiver 220 and data being received via transceiver 220. Data processor 290 may also control the operation of various circuits within transceiver 220.

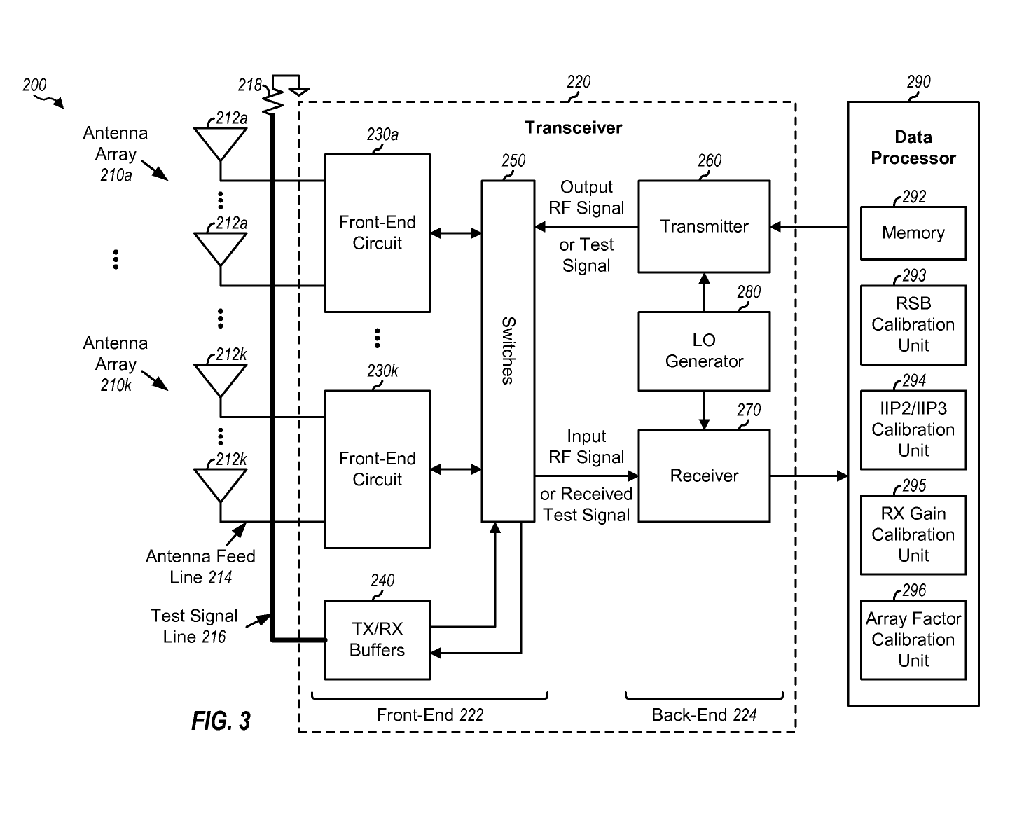

FIG. 3 shows a block diagram of an exemplary design of transceiver 220 within wireless device 200 in FIG. 2. Transceiver 220 includes a front-end 222 and a back-end 224. Front-end 222 includes K front-end circuits 230a to 230k, TX/RX buffers 240, and switches 250. Back-end 224 includes a transmitter 260, a receiver 270, and an LO generator 280.

Front-end circuits 230a to 230k are coupled to antenna arrays 210a to 210k, respectively. Each front-end circuit 230 includes transmit (TX) circuits to process an output RF signal from transmitter 260 and provide transmit RF signals to antenna elements 212 in the transmit direction. Each front-end circuit 230 also includes receive (RX) circuits to process received RF signals from antenna elements 212 and provide an input RF signal to receiver 270 in the receive direction. TX/RX buffers 240 are coupled to test signal line 216, which may also be referred to as a BIST line. TX/RX buffers 240 provide a test signal on test signal line 216 when testing RX circuits in transceiver 220. TX/RX buffers 240 also buffer a received test signal from test signal line 216 when testing TX circuits in transceiver 220.

Switches 250 are coupled to front-end circuits 230a to 230k, TX/RX buffers 240, transmitter 260, and receiver 270. Switches 250 may route (i) an output RF signal from transmitter 260 to one or more front-end circuits 230a to 230k or (ii) a test signal from transmitter 260 to TX/RX buffers 240. Switches 250 may also route (i) one or more input RF signals from one or more front-end circuits 230a to 230k to receiver 270 or (ii) a received test signal from TX/RX buffers 240 to receiver 270.

Transceiver 220 may operate in a normal operating mode or a test/calibration mode at any given moment. Transmitter 260 may generate (i) an output RF signal in the normal operating mode or (ii) a test signal in the test/calibration mode. Receiver 270 may process (i) an input RF signal in the normal operating mode or (ii) a received test signal in the test/calibration mode. LO generator 280 may generate a transmit LO signal for transmitter 260 and/or a receive LO signal for receiver 270.

FIG. 3 shows an exemplary design of transceiver 220. A transceiver may include additional, fewer, or different circuits. All or a portion of transceiver 220 may be implemented on one or more analog ICs, RF ICs (RFICs), mixed-signal ICs, etc.

FIG. 3 also shows an exemplary design of data processor 290 within wireless device 200 in FIG. 2. Data processor 290 includes a memory 292 to store program codes and data for data processor 290. Data processor 290 may also include various units to test/calibrate TX circuits and RX circuits within transceiver 220. For example, data processor 290 may include a unit 293 that facilitates residual sideband (RSB) calibration, a unit 294 that facilitates second-order input intercept point (IIP2) and/or third-order input intercept point (IIP3) calibration, a unit 295 that facilitates receive (RX) gain calibration, and/or a unit 296 that facilitates determination of an array factor for each antenna array 210. Each unit may facilitate testing/calibration of a particular parameter by controlling generation of test signals and/or control signals, making measurements, performing computations, and/or performing other task for testing/calibration the particular parameter. Each unit may be implemented in software, hardware, firmware, or a combination thereof. Data processor 290 may be implemented on one or more application specific integrated circuits (ASICs) and/or other ICs.

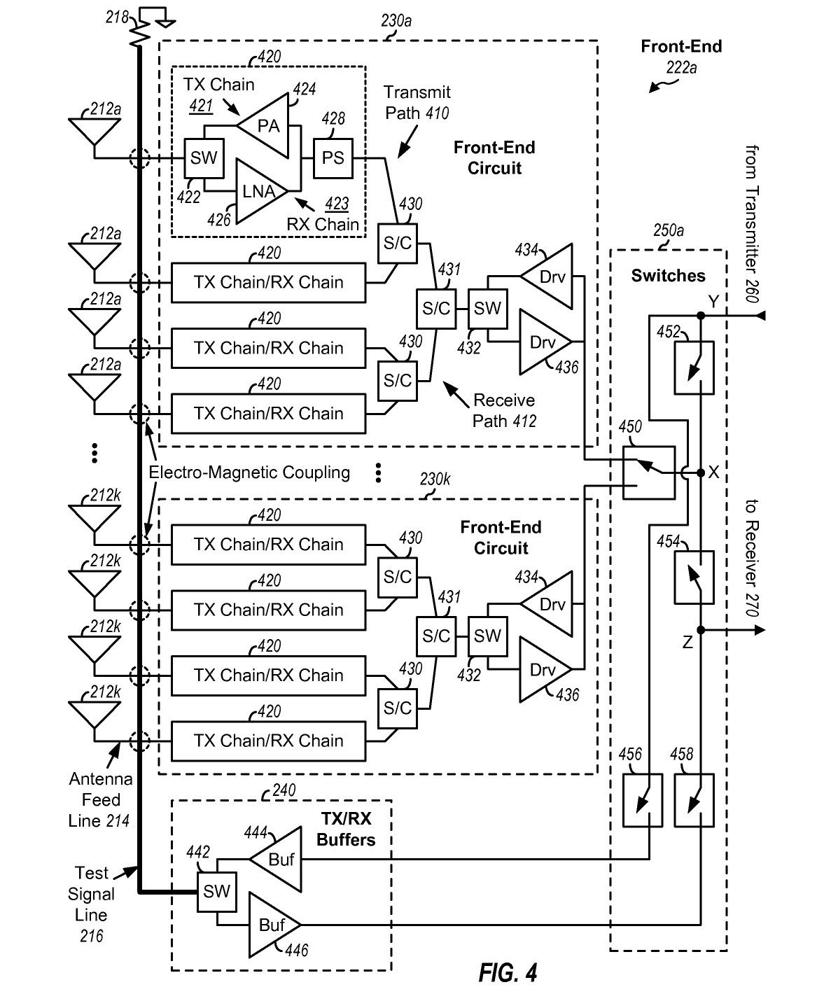

FIG. 4 shows a schematic diagram of a front-end 222a, which is an exemplary design of front-end 222 of transceiver 220 in FIG. 3. Front-end 222a includes front-end circuits 230a to 230k, TX/RX buffers 240, and switches 250a. Switches 250a are an exemplary design of switches 250 in FIG. 3. In the exemplary design shown in FIG. 4, front-end circuit 230 for each antenna array 210 includes a TX chain/RX chain 420 for each antenna element 212 of the antenna array, splitters/combiners (S/C) 430 and 431, a switch (SW) 432, a transmit driver (Dry) 434, and a receive driver 436. Each TX chain/RX chain 420 includes a TX chain 421 and an RX chain 423.

In the exemplary design shown in FIG. 4, each TX chain/RX chain 420 includes a switch 422, a power amplifier (PA) 424 in the transmit direction, a low noise amplifier (LNA) 426 in the receive direction, and a phase shifter (PS) 428. PA 424 has its input coupled to phase shifter 428 and its output coupled to switch 422. LNA 426 has its input coupled to switch 422 and its output coupled to phase shifter 428. Switch 422 is further coupled to an associated antenna element 212. Switch 422 may be used for time division duplexing (TDD) and may be replaced with a duplexer for frequency division duplexing (FDD).

In general, a TX chain is a circuit block that includes at least one circuit to process a signal in a transmit direction. The at least one circuit in a TX chain may include a PA, a switch, a duplexer, a diplexer, a phase splitter, some other circuit, or a combination thereof. An RX chain is a circuit block that includes at least one circuit to process a signal in a receive direction. The at least one circuit in an RX chain may include an LNA, a switch, a duplexer, a diplexer, a phase splitter, some other circuit, or a combination thereof. A TX chain and an RX chain may share one or more circuits such as a switch, a duplexer, a diplexer, a phase splitter, etc.

In the exemplary design shown in FIG. 4, front-end 222a includes a number of transmit paths 410 from transmitter 260 to antenna elements 210. Front-end 222a also includes a number of receive paths 412 from antenna elements 210 to receiver 270.

In general, a transmit path is a signal path in the transmit direction and includes at least one circuit to process a signal in the transmit direction. For example, a transmit path may correspond to a signal path from switches 250a to one antenna element 212 in FIG. 4. A transmit path may include one or more circuits in a TX chain and/or other circuits. Multiple transmit paths may share one or more circuits such as one or more signal splitters, switches, etc. A receive path is a signal path in the receive direction and includes at least one circuit to process a signal in the receive direction. For example, a receive path may correspond to a signal path from one antenna element 212 to switches 250a in FIG. 4. A receive path may include one or more circuits in an RX chain and/or other circuits. Multiple receive paths may share one or more circuits such as one or more signal combiners, switches, etc.

Each front-end circuit 230 includes N TX chains/RX chains 420 for N antenna elements 212 of an antenna array 210 to which front-end circuit 230 couples. The N TX chains/RX chains 420 are coupled via a suitable number of signal splitters/combiners 430 and 431. Each signal splitter/combiner 430 or 431 may include a signal splitter in the transmit direction and a signal combiner in the receive direction. In the exemplary design shown in FIG. 4, each front-end circuit 230 includes four TX chain/RX chains 420 for four antenna elements 212 of an associated antenna array 210. Each front-end circuit 230 further includes two signal splitters/combiners 430 and one signal splitter/combiner 431. Each pair of TX chains/RX chains 420 is coupled to a respective signal splitter/combiner 430, and the two signal splitters/combiners 430 are coupled to signal splitter/combiner 431.

Within each front-end circuit 230, signal splitter/combiner 431 is coupled to switch 432. TX driver 434 has its input coupled to switches 250a and its output coupled to switch 432. RX driver 436 has its input coupled to switch 432 and its output coupled to switches 250a.

In the exemplary design shown in FIG. 4, TX/RX buffers 240 include a switch 442, a TX buffer 444, and an RX buffer 446. TX buffer 444 has its input coupled to switches 250a and its output coupled to switch 442. RX buffer 446 has its input coupled to switch 442 and its output coupled to switches 250a. Switch 442 is further coupled to one end of test signal line 216, and the other end of test signal line 216 is coupled to a resistor 218. Resistor 218 provides termination of test signal line 216 and may have a value of 50 Ohms (Q) or some other value.

In the exemplary design shown in FIG. 4, TX buffer 444 is used to buffer a test signal from transmitter 260 and provide a buffered test signal on test signal line 216. RX buffer 446 is used to buffer a received test signal from test signal line 216 and provide a buffered received test signal to receiver 270. TX buffer 444 and RX buffer 446 perform buffering and further isolate mixers within transmitter 260 and receiver 270 from a PCB, which may mitigate performance degradation during BIST.

In the exemplary design shown in FIG. 4, switches 250a includes switches 450 to 458 to interconnect front-end circuits 230a to 230k and TX/RX buffers 240 with transmitter 260 and receiver 270. A single-pole-K-throw switch 450 has its single pole coupled to node X and its K throws coupled to the K front-end circuits 230a to 230k. A switch 452 has one end coupled to node X and the other end coupled to the output of transmitter 260 at node Y. A switch 454 has one end coupled to node X and the other end coupled to the input of receiver 270 at node Z. A switch 456 has one end coupled to the input of TX buffer 444 and the other end coupled to the output of transmitter 260. A switch 458 has one end coupled to the output of RX buffer 446 and the other end coupled to the input of receiver 270.

In the normal operating mode, an output RF signal may be routed from transmitter 260 to a selected front-end circuit 230 by closing switch 452, connecting switch 450 to a throw to which the selected front-end circuit 230 is coupled, and opening switch 456. An input RF signal may be routed from a selected front-end circuit 230 to receiver 270 by closing switch 454, connecting switch 450 to a throw to which the selected front-end circuit 230 is coupled, and opening switch 458. In the test/calibration mode, an output test signal may be routed from transmitter 260 to TX buffer 444 by closing switch 456 and opening switch 452. A received test signal may be routed from RX buffer 446 to receiver 270 by closing switch 458 and opening switch 454.

In the exemplary design shown in FIG. 4, switches 456 and 458 are used to improve isolation between test signal line 216 and transmitter 260 and receiver 270. In another exemplary design, switches 456 and 458 may be omitted, TX buffer 444 may be coupled to the output of transmitter 260, and RX buffer 446 may be coupled to the input of receiver 270. TX buffer 444 and RX buffer 446 may be disabled during the normal operating mode and may isolate test signal line 216 from transmitter 260 and receiver 270.

Switches 250a may also be implemented in other manners. For example, each front-end circuit 230 may be coupled to node X via a separate single-pole-single-throw switch. This may enable the output RF signal to be routed to any one or any combination of front-end circuits 230.

In an exemplary design, the circuits in transceiver 220 may be implemented on an IC chip (e.g., an RFIC), and antenna elements 212a to 212k may be implemented external to the IC chip. Each TX chain/RX chain 420 may be coupled to an associated antenna element 212 via a respective input/output (I/O) pin on the IC chip. Test signal line 216 may be implemented external to the IC chip, e.g., on the same circuit board on which antenna elements 212 are implemented. In an exemplary design, resistor 218 may be implemented external to the IC chip, and test signal line 216 may be coupled to TX/RX buffers 240 via one I/O pin on the IC chip. In another exemplary design, resistor 218 may be implemented on the IC chip, and test signal line 216 may be coupled to two I/O pins on the IC chip, e.g., to TX/RX buffers 240 via one I/O pin and to resistor 218 within the IC chip via another I/O pin. In another exemplary design, test signal line 216 and transceiver 220 may be implemented on the same IC chip.

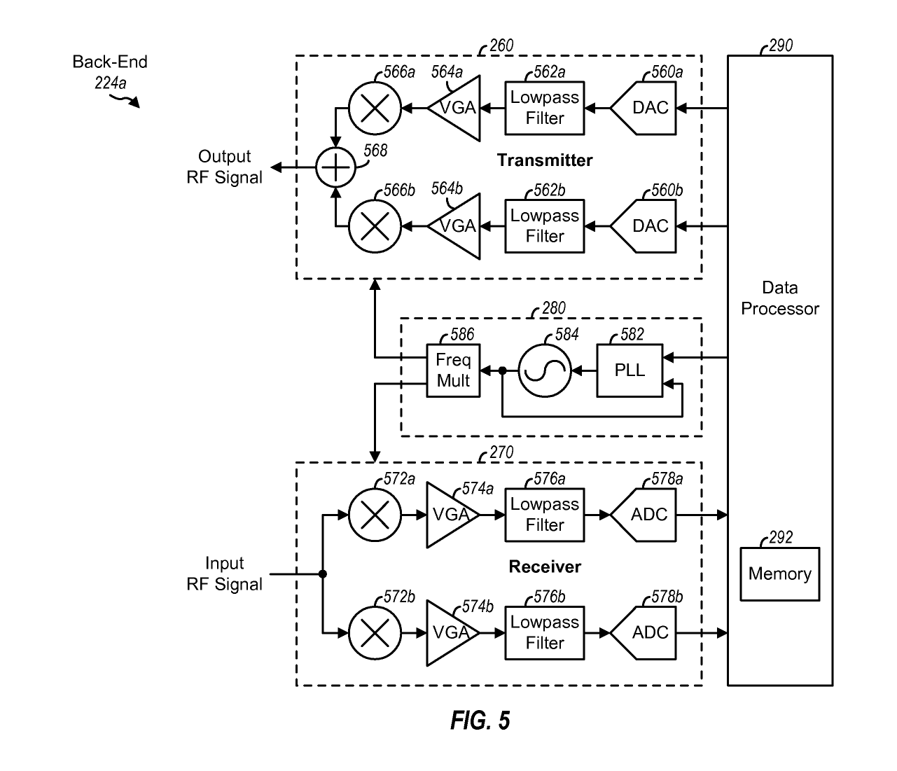

FIG. 5 shows a schematic diagram of a back-end 224a, which is an exemplary design of back-end 224 of transceiver 220 in FIG. 2. Back-end 224a includes transmitter 260, receiver 270, and LO generator 280. In the exemplary design shown in FIG. 5, transmitter 260 includes (i) a digital-to-analog converter (DAC) 560a, a lowpass filter 562a, a variable gain amplifier (VGA) 564a, and a mixer 566a for an inphase (I) transmit path and (ii) a DAC 560b, a lowpass filter 562b, a VGA 564b, and a mixer 566b for a quadrature (Q) transmit path. Transmitter 260 further includes a summer 568 coupled to mixers 566a and 566b. In the exemplary design shown in FIG. 5, receiver 270 includes (i) a mixer 572a, a VGA 574a, a lowpass filter 576a, and an analog-to-digital converter (ADC) 578a for an I receive path and (ii) a mixer 572b, a VGA 574b, a lowpass filter 576b, and an ADC 578b for a Q receive path.

In the exemplary design shown in FIG. 5, LO generator 280 includes a phase locked loop (PLL) 582, a voltage-controlled oscillator (VCO) 584, and a frequency multiplier (Freq Mult) 586. VCO 584 receives a control signal from PLL 582 and generates a VCO signal at a desired frequency determined by the control signal, which may be 15 GHz for IEEE 802.11ad or some other frequency. Frequency multiplier 586 multiplies the VCO signal in frequency (e.g., by a factor of 4) and provides an LO signal (e.g., at a frequency of 60 GHz for IEEE 802.11ad). PLL 582 receives a reference signal and the VCO signal from VCO 584, compares the phase of the VCO signal against the phase of the reference signal, and generates the control signal for VCO 584 such that the phase of the VCO signal is locked to the phase of the reference signal. LO generator 280 may also be implemented in other manners.

For data transmission, data processor 290 processes (e.g., encodes and modulates) data to be transmitted and provides I and Q output samples to transmitter 260. Within transmitter 260, the I and Q output samples are converted to analog signals by DACs 560a and 560b, filtered by lowpass filters 562a and 562b, amplified by VGAs 564a and 564b, upconverted by mixers 566a and 566b, and summed by summer 568 to generate an output RF signal. Referring back to FIG. 4, the output RF signal is routed through switches 250a and provided to a selected front-end circuit 230. Within the selected front-end circuit 230, the output RF signal is buffered by TX driver 434, routed through switch 432, and split by signal splitters 430 and 431 to obtain an output RF signal for each TX chain/RX chain 420 within the selected front-end circuit 230. Within each TX chain/RX chain 420, the output RF signal is phase shifted by phase shifter 428 by an amount selected for an associated antenna element 212. The phase-shifted output RF signal is amplified by PA 424 to generate a transmit RF signal, which is routed through switch 422 and transmitted via the associated antenna element 212. Different phase shifts may be applied for different antenna elements 212 to obtain a desired antenna beam.

For data reception, antenna elements 212 receive signals from base stations and/or other stations, and each antenna element 212 provides a respective received RF signal to an associated TX chain/RX chain 420. Within each TX chain/RX chain 420, the received RF signal is routed through switch 422, amplified by LNA 426, and phase shifted by phase shifter 428 by an amount selected for the associated antenna element 212. The phase-shifted received RF signals from all TX chains/RX chains 420 in the same front-end circuit 230 are combined by signal combiners 430 and 431, routed through switch 432, and buffered by RX driver 436 to obtain an input RF signal. The input RF signal is routed through switches 250a and provided to receiver 270. Referring back to FIG. 5, within receiver 270, the input RF signal is downconverted by mixers 572a and 572b, amplified by VGAs 574a and 574b, filtered by lowpass filters 576a and 576b, and digitized by ADCs 578a and 578b to obtain I and Q input samples, which are provided to data processor 290.

FIGS. 4 and 5 show an exemplary design of transceiver 220. Transceiver 220 may include additional, fewer, or different circuits. For example, transceiver 220 may include switches, duplexers, diplexers, transmit filters, receive filters, matching circuits, an oscillator, etc. FIG. 5 shows an exemplary design of transmitter 260 and receiver 270. Transmitter 260 and receiver 270 may each include additional, fewer, or different circuits. The circuits in transmitter 260 and/or receiver 270 may also be arranged differently than the arrangement shown in FIG. 5. For example, DACs 560 and ADCs 578 may be part of transceiver 220 (as shown in FIG. 5) or may be part of data processor 290. All or a portion of transceiver 220 may be implemented on one or more analog ICs, RFICs, mixed-signal ICs, etc.

Front-end 222a in FIG. 4 and back-end 224a in FIG. 5 may operate in the normal operating mode or the test/calibration mode at any given moment. For data transmission in the normal operating mode, transmitter 260 may generate an output RF signal, which may be processed by one or more selected front-end circuits 230 and transmitted via associated antenna elements 212. For data reception in the normal operating mode, antenna elements 212 may provide received RF signals, which may be processed by one or more selected front-end circuits 230 and provided to receiver 270.

The test/calibration mode may support a TX BIST configuration, an RX BIST configuration, and/or a TX-RX loop-back BIST configuration. The TX BIST configuration may be used to test/calibrate TX circuits (e.g., PAs 424 or TX chains 421) in front-end 222a. The RX BIST configuration may be used to test/calibrate RX circuits (e.g., LNAs 426 or RX chains 423) in front-end 222a. The TX-RX loop-back BIST configuration may be used to test/calibrate TX circuits and RX circuits in front-end 222a.

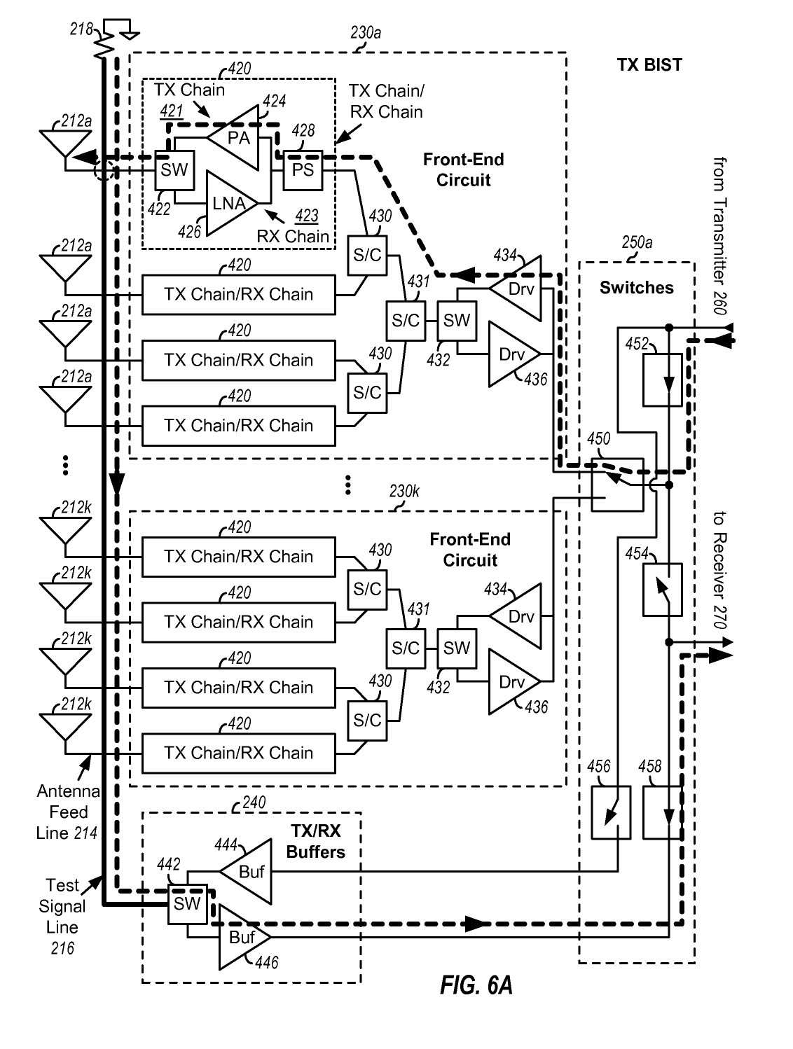

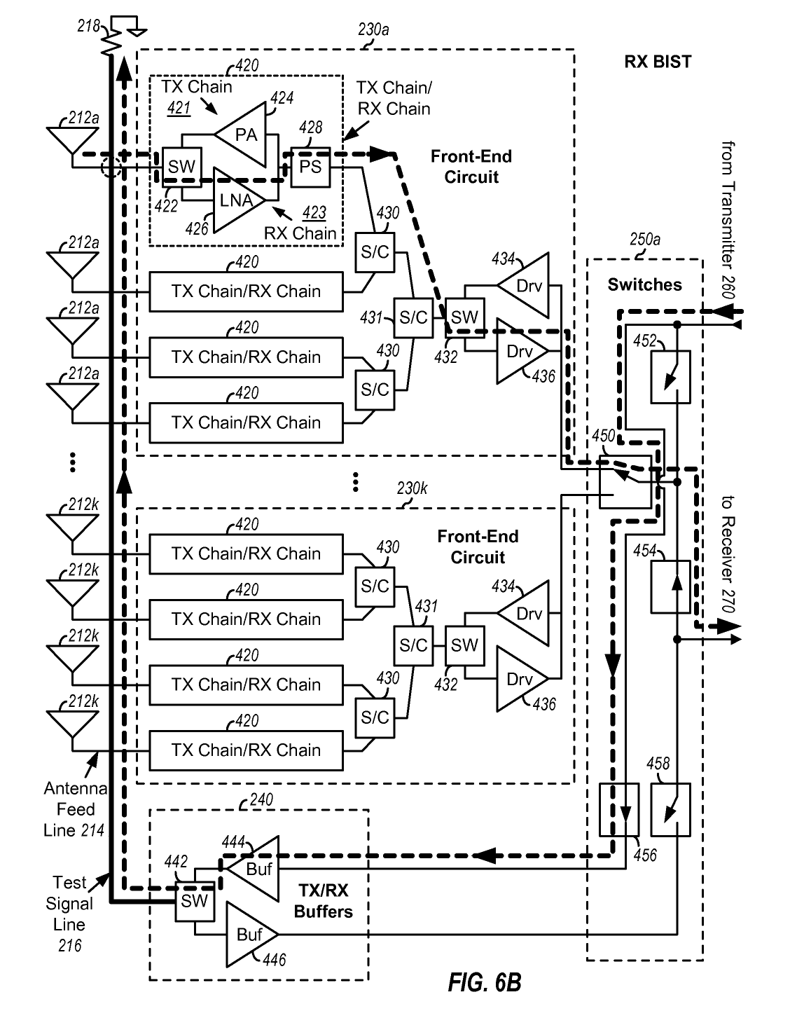

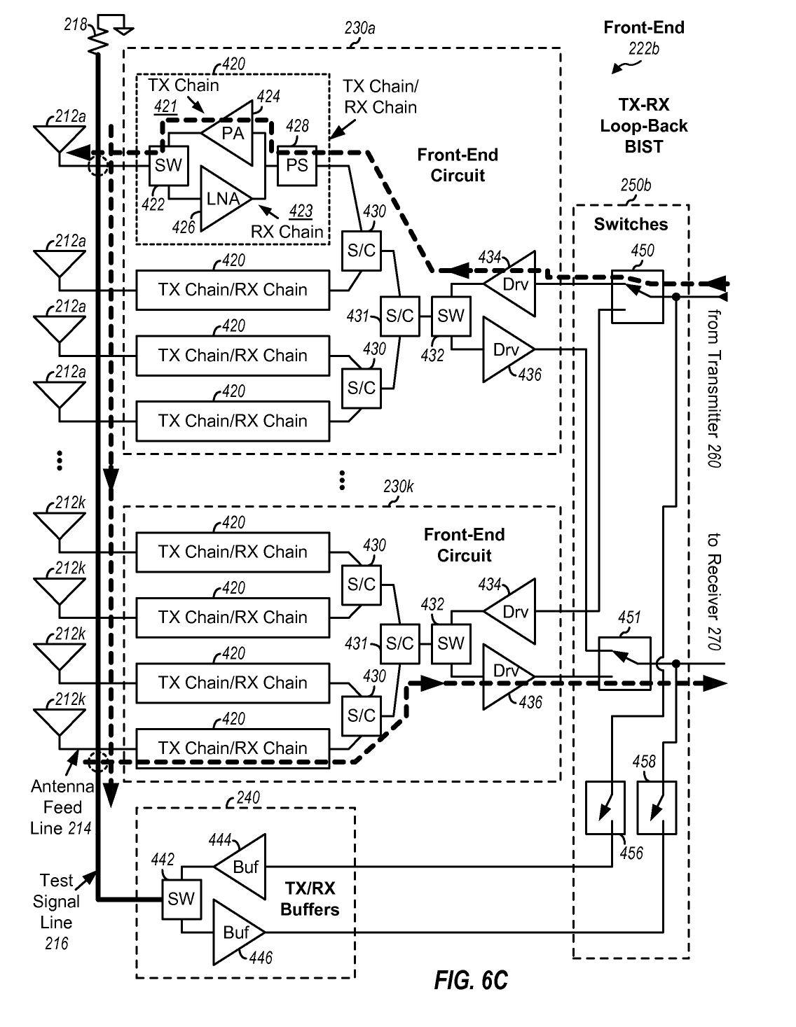

FIG. 6A shows the TX BIST configuration for front-end 222a in FIG. 4. Transmitter 260 may generate a test signal at a target frequency in the test mode. The test signal may be a tone signal at the target frequency, which may be 60 GHz for IEEE 802.11ad or some other frequency. The test signal may also be an amplitude modulated (AM) signal centered at the target frequency. The test signal may be routed through switches 450 and 452 and provided to a selected front-end circuit 230 being tested. Within the selected front-end circuit 230, the test signal may be buffered by TX driver 434, routed through switch 432, passed through signal splitters 430 and 431, and provided to TX chains/RX chains 420. Within each TX chain/RX chain 420, the test signal may be phase shifted by phase shifter 428, amplified by PA 424, routed through switch 422 and antenna feed line 214, and transmitted via an antenna element 212 coupled to that TX chain/RX chain 420.

Test signal line 216 may receive the test signal via electro-magnetic coupling between test signal line 216 and antenna feed lines 214. The received test signal on test signal line 216 may be routed through switch 442, buffered by RX buffer 446, routed through switch 458, and provided to receiver 270. The received test signal may be downconverted, amplified, filtered, and digitized by receiver 270 to obtain input samples. Data processor 290 may process the input samples for various tests such as RSB, IIP2 and/or IIP3, FQ imbalance, RX gain calibration, array factor calibration, etc.

TX chains 421 within transceiver 220 may be tested/calibrated in various manners in the TX BIST configuration. In a first exemplary design, one TX chain 421 may be tested/calibrated at a time. In this exemplary design, only one PA 424 in one TX chain 421 for one TX chain/RX chain 420 under test may be enabled, and other PAs 424 in remaining TX chains/RX chains 420 may be disabled. In a second exemplary design, all TX chains 421 in one front-end circuit 230 may be tested at a time. In this exemplary design, PAs 424 in all TX chains 421 for all TX chains/RX chains 420 in one front-end circuit 230 under test may be enabled, and other PAs 424 in remaining TX chains/RX chains 420 may be disabled. In a third exemplary design, all TX chains 421 in multiple (e.g., all) front-end circuits 230 may be tested at the same time. In this exemplary design, PAs 424 in TX chains 421 for TX chains/RX chains 420 in multiple (e.g., all) front-end circuits 230 under test may be enabled, and other PAs 424 in remaining front-end circuits 230 (if any) may be disabled. The third exemplary design may be used to determine an array factor.

FIG. 6B shows the RX BIST configuration for front-end 222a in FIG. 4. Transmitter 260 may generate a test signal at a target frequency in the test mode. The test signal may be a tone signal or an AM signal at the target frequency. The test signal may be routed through switch 456, buffered by TX buffer 444, routed through switch 442, and radiated via test signal line 216. Antenna feed lines 214 may receive the test signal via electro-magnetic coupling with test signal line 216. A received test signal from each antenna feed line 214 may be routed through switch 422, buffered by LNA 426, phase shifted by phase shifter 428, and passed through signal combiners 430 and 431. The combined received test signal from signal combiner 431 may be routed through switch 432, buffered by RX driver 436, routed through switches 450 and 454, and provided to receiver 270. The received test signal may be downconverted, amplified, filtered, and digitized by receiver 270 to obtain input samples. Data processor 290 may process the input samples for various tests.

RX chains 423 within transceiver 220 may be tested/calibrated in various manners in the RX BIST configuration. In a first exemplary design, one RX chain 423 may be tested at a time. In this exemplary design, only one LNA 426 in one RX chain 423 for one TX chain/RX chain 420 under test may be enabled, and other LNAs 426 in remaining TX chains/RX chains 420 may be disabled. In a second exemplary design, all RX chains 423 in one front-end circuit 230 may be tested at a time. In this exemplary design, LNAs 426 in all RX chains 423 for all TX chains/RX chains 420 in one front-end circuit 230 under test may be enabled, and other LNAs 426 in remaining front-end circuits 230 may be disabled. In a third exemplary design, all RX chains 423 in multiple (e.g., all) front-end circuits 230 may be tested at the same time. In this exemplary design, LNAs 426 in RX chains 423 in all front-end circuits 230 under test may be enabled, and other LNAs 426 in remaining front-end circuits 230 (if any) may be disabled. The third exemplary design may be used to determine an array factor.

FIG. 6C shows a schematic diagram of a front-end 222b, which is another exemplary design of front-end 222 of transceiver 220 in FIG. 3. Front-end 222b includes all of the circuits in front-end 222a in FIG. 4 with the following differences. Front-end 222b includes switches 250b instead of switches 250a in front-end 222a. Switches 250b include (i) switches 450, 456 and 458 in switches 250a and (ii) a single-pole-K-throw switch 451 in place of switches 452 and 454 in switches 250a. Switch 451 has its single pole coupled to the input of receiver 270 and its K throws coupled to the outputs of RX drivers 436 in K front-end circuits 230a to 230k. Switch 450 has its single pole coupled to the output of transmitter 260 and its K throws coupled to the inputs of TX drivers 434 in K front-end circuits 230a to 230k.

FIG. 6C also shows a TX-RX loop-back BIST configuration for front-end 222b. Transmitter 260 may generate a test signal at a target frequency in the test mode. The test signal may be routed through switch 450 and provided to a selected front-end circuit 230 whose TX circuits are being tested, which is front-end circuit 230a in the example shown in FIG. 6C. Within front-end circuit 230a, the test signal may be buffered by TX driver 434, routed through switch 432, passed through signal splitters 430 and 431, and provided to one or more selected TX chains/RX chains 420. Within each selected TX chain/RX chain 420, the test signal may be phase shifted by phase shifter 428, amplified by PA 424, routed through switch 422 and antenna feed line 214, and transmitted via antenna element 212. The test signal may be electro-magnetically coupled from antenna feed lines 214 for front-end circuit 230a to test signal line 216. The coupled test signal on test signal line 216 may be electro-magnetically coupled to antenna feed lines 214 for another selected front-end circuit 230 whose RX circuits are being tested, which is front-end circuit 230k in the example shown in FIG. 6C. A received test signal from each antenna feed line 214 for front-end circuit 230k may be routed through switch 422, buffered by LNA 426, phase shifted by phase shifter 428, and passed through signal combiners 430 and 431 within front-end circuit 230k. The combined received test signal from signal combiner 431 may be routed through switch 451 and provided to receiver 270. The received test signal may be downconverted, amplified, filtered, and digitized by receiver 270 to obtain input samples. Data processor 290 may process the input samples for various tests.

As shown in FIG. 6A, RX buffer 446 may provide isolation of mixer 572 within receiver 270 when RX buffer 446 is turned ON in the TX BIST configuration. As shown in FIG. 6B, TX buffer 444 may provide isolation of mixer 566 within transmitter 260 when TX buffer 444 is turned ON in the RX BIST configuration. TX buffer 444 and RX buffer 446 may also improve isolation when they are turned OFF in the normal operating mode.

Table 1 lists TX and RX configurations in the normal operating mode (which are referred to as “normal TX” and “normal RX”) as well as the TX and RX BIST configurations in the test mode (which are referred to as “TX BIST” and “RX BIST”). Table 1 also lists the states of some TX circuits and RX circuits and the states of the switches for each configuration of each mode.

TABLE 1

| | Mode and Configuration | | | |
|---|---|---|---|---|
| | Normal TX | Normal RX | TX BIST | RX BIST |
| TX mixers 566 | On | Off | On | On |
| TX buffer 444 | Off | Off | Off | On |
| RX mixers 572 | Off | On | On | On |
| RX buffer 446 | Off | Off | On | Off |
| Switch 450 state | Upper or | Upper or | Upper or | Upper or |
| | Lower | Lower | Lower | Lower |
| Switch 452 state | On | Off | On | Off |
| Switch 454 state | Off | On | Off | On |
| Switch 456 state | Off | Off | Off | On |
| Switch 458 state | Off | Off | On | Off |
| RX Chain | Off | On | Off | On |
| TX Chain | On | Off | On | Off |

Table 2 lists various tests that may be performed for TX circuits and/or RX circuits based on the BIST capability. A TX power test may be performed to measure the transmit power of a transmit RF signal provided to an antenna element 212. The TX power test may facilitate automatic power control (APC). APC may be used to raise a lower output power when needed (e.g., in case of a lower power supply voltage, manufacturing defect, or dynamic adjustment) in order to improve performance (e.g., achieve better error vector magnitude (EVM)). A TX gain test may be performed to measure the gain of a TX signal path, e.g., from transmitter 260 to an antenna element 212. A TX EVM test may be performed to (i) measure gain and/or phase mismatch between I and Q paths of a TX signal path and/or (ii) determine the amount of leakage of a transmit LO signal provided to mixers 566 within transmitter 260. An LO power test may be performed to measure the power level of the transmit LO signal. A TX phase state test may be performed to determine the phase of a TX signal path.

An RX gain test may be performed to measure the gain of an RX signal path, e.g., from an antenna element 212 to receiver 270. An RX EVM test may be performed to (i) measure gain and/or phase mismatch between I and Q paths of an RX signal path and/or (ii) determine the amount of leakage of a receive LO signal provided to mixers 572 within receiver 270. An RX phase state test may be performed to determine the phase of an RX signal path. An RX antenna array factor test may be performed to determine an array factor of an antenna array 210 for signal reception.

Other tests may also be performed based on the BIST capability. For example, an overall TX and RX EVM test may be performed using TX-RX loop-back and modem processing to measure gain and/or phase mismatch between I and Q paths of a TX signal path and an RX signal path. As another example, a test may check antenna connection to chip, with a low gain for TX circuits or RX circuits indicating faulty assembly. IC chip level tests may be performed based on similar circuit topology.

TABLE 2

| | Test | Calibration |
|---|---|---|
| TX Circuits | Power | Power and APC |
| | Gain, EVM | EVM (I/Q mismatch, carrier leakage) |
| | LO power | |
| | Phase state | |
| RX Circuits | Gain | AGC |
| | Array factor | Array factor |
| | Phase state, EVM | EVM (I/Q mismatch, carrier leakage) |

An array factor test may be performed to determine an array factor of an antenna array 210 as follows. First, TX buffer 444 may be turned ON as shown in FIG. 6B. One RX chain 423 for one antenna element 212 of one selected antenna array 210 may be turned ON, and remaining RX chains 423 may be turned OFF. A test signal may be generated by transmitter 260, buffered by TX buffer 444, radiated via test signal line 216, electro-magnetically coupled to antenna feed lines 214, processed by the one RX chain 423, and provided to receiver 270. The gain and phase of the received test signal may be measured. The process may be repeated to measure the gain and phase of each RX chain 423 for each antenna element 212 of the selected antenna array 210. A complex gain (which may be represented by a gain and a phase) may be obtained for each RX chain 423 for the selected antenna array 210.

An RX chain 423 with the largest gain may be used as a reference and may be referred to as a reference RX chain. The complex gain of each RX chain 423 may be normalized by the complex gain of the reference RX chain gain. If four RX chains 1, 2, 3 and 4 are measured for four antenna elements 212 of the selected antenna array 210, and if RX chain 1 has the largest gain, then the normalized complex gains of RX chains 2, 3 and 4 may be denoted as (g_{1,2}, φ_{1,2}), (g_{1,3}, φ_{1,3}), and (g_{1,4}, φ_{1,4}), where g_{1,i} denotes the gain of RX chain i relative to the gain of the reference RX chain 1, and φ_{1,i} denotes the phase of RX chain i relative to the phase of the reference RX chain 1.

Relative displacement between antenna elements 212 of the selected antenna array 210 may be referred to as a distance d between antenna elements 212. The accuracy of the relative displacement between antenna elements 212 may be checked, as follows:

$$\begin{matrix}\frac{{φ}_{1 , 3} - {φ}_{1 , 2}}{d * β} - integer ( \frac{{φ}_{1 , 3} - {φ}_{1 , 2}}{d * β} ) , & Eq ( 1 ) \\ β = 2 π / λ , and & Eq ( 2 ) \\ λ = \frac{C}{f \sqrt{{ɛ}_{r}}} , & Eq ( 3 )\end{matrix}$$

where C denotes the speed of light in a vacuum,

f denotes an operating frequency of a wireless device,

λdenotes a wavelength of a transmitted signal,

d denotes a distance between antenna elements 212 of selected antenna array 210,

∈ᵣ denotes a dielectric constant, and

β denotes a wave number.

Losses between antenna elements 212 relative to a reference antenna element with the highest power may be determined and denoted as IL_{1,2}, IL_{1,3}, and IL_{1,4}. Amplitude compensation and power summation may then be performed. Power summation with compensation against the power of a single antenna element 212 may be computed to obtain a scalar array factor in units of decibels (dB).

As shown in FIGS. 6A to 6C, TX circuits and/or RX circuits within transceiver 220 may be tested/calibrated using test signal line 216 in the test mode. The test mode can test the TX circuits and/or RX circuits as well as the connectivity of these circuits to antenna elements 212 on a PCB. Transmitter 260, receiver 270, LO generator 280, signal splitters/combiners 430 and 431, and switches 250 may be reused in the test mode to (i) generate a test signal for transmission via antenna element 212 or test signal line 216 and (ii) process a received test signal. Reusing transmitter 260, receiver 270, and LO generator 280 for testing may (i) reduce the amount of extra circuitry needed to support BIST and (ii) avoid the need for an external signal generator to generate a test signal for testing.

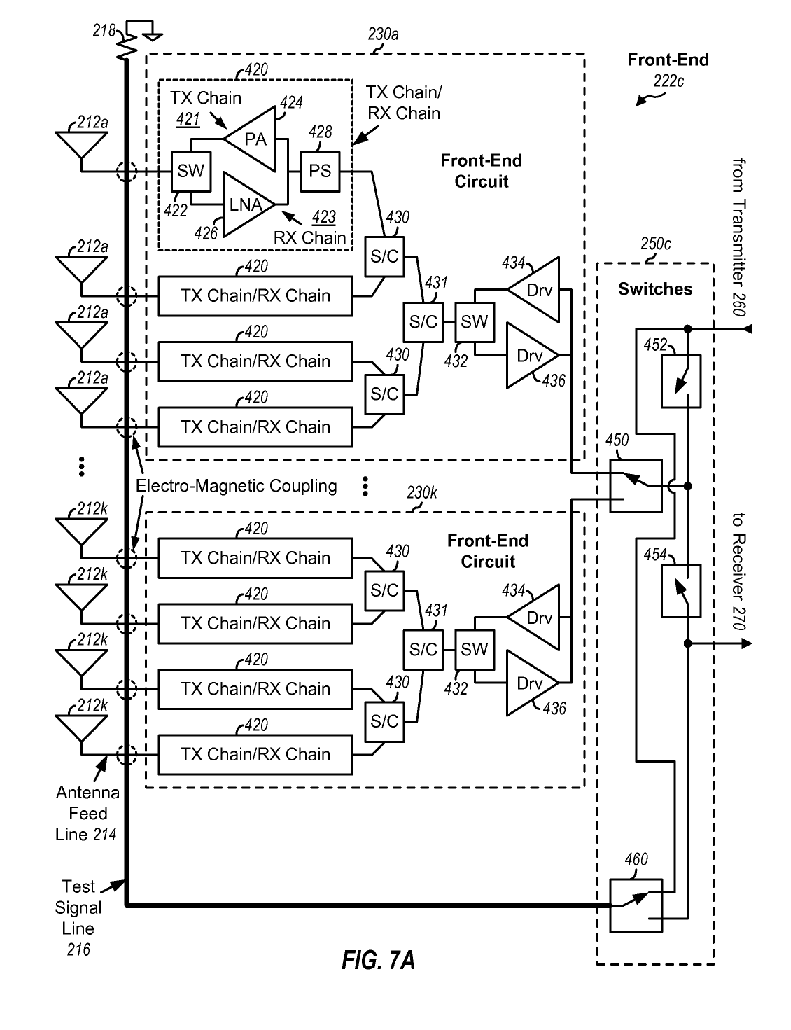

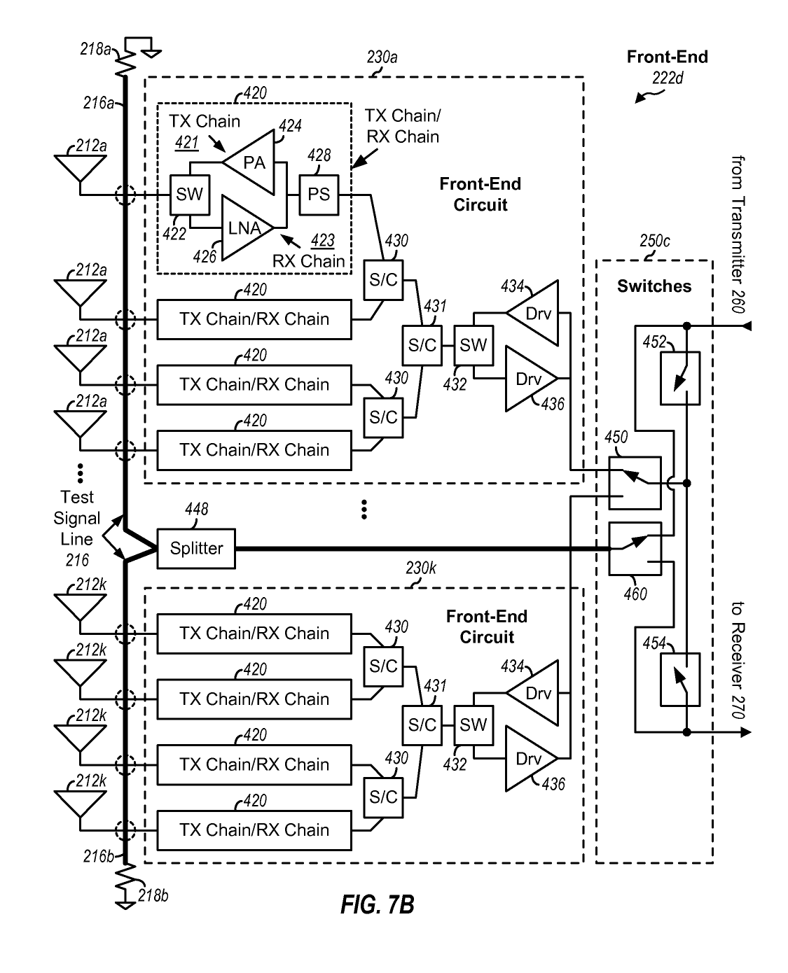

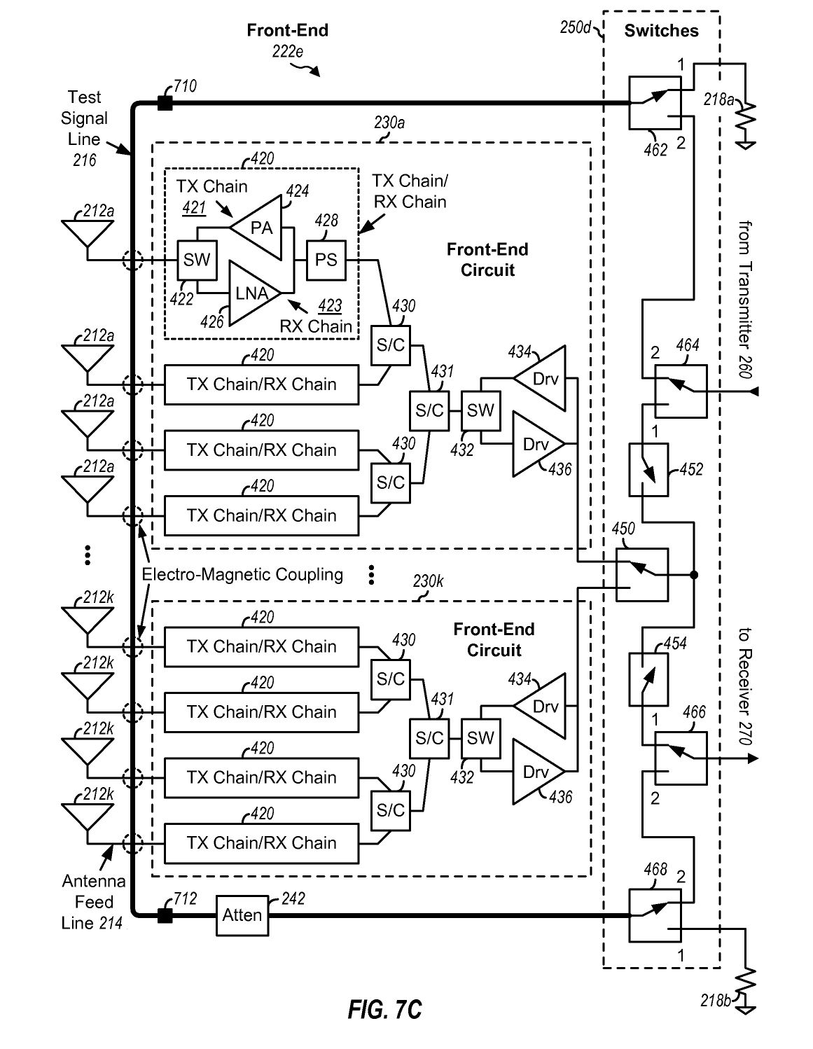

FIG. 7A shows a schematic diagram of a front-end 222c, which is yet another exemplary design of front-end 222 of transceiver 220 in FIG. 3. Front-end 222c includes all of the circuits in front-end 222a in FIG. 4 with the following differences. In FIG. 4, test signal line 216 is coupled to TX/RX buffers 240, which is further coupled to transmitter 260 via switch 456 and to receiver 270 via switch 458. In FIG. 7A, TX/RX buffers 240 are omitted.

Front-end 222c further includes switches 250c in place of switches 250a in FIG. 4. Switches 250c include switches 450, 452 and 454 in switches 250a. Switches 456 and 458 in switches 250a are replaced with a single-pole-double-throw (SPDT) switch 460 in switches 250c. Switch 460 has its single pole coupled to test signal line 216, its first throw coupled to the output of transmitter 260, and its second throw coupled to the input of receiver 270. Transmitter 260 may provide a test signal to test signal line 216 via switch 460. Receiver 270 may be provided with a received test signal from test signal line 216 via switch 460.

FIG. 7B shows a schematic diagram of a front-end 222d, which is yet another exemplary design of front-end 222 of transceiver 220 in FIG. 3. Front-end 222d includes all of the circuits in front-end 222c in FIG. 7A with the following differences. In FIG. 7A, test signal line 216 is routed past all antenna elements 212 and has a first end coupled to TX/RX buffers 240 and a second end terminated by resistor 218. In FIG. 7B, a signal splitter 448 is located between front-end circuits 230a to 230k and may be implemented with a Wilkinson splitter or a signal splitter of some other type. Test signal line 216 is split into a first test signal line segment 216a and a second test signal line segment 216b. First test signal line segment 216a is routed past antenna elements 212 located on a first side of signal splitter 448 and has one end coupled to signal splitter 448 and the other end terminated by a resistor 218a. Second test signal line segment 216b is routed past antenna elements 212 located on a second side of signal splitter 448 and has one end coupled to signal splitter 448 and the other end terminated by a resistor 218b. Signal splitter 448 is coupled to the single pole of switch 460. In the exemplary design shown in FIG. 7B, TX/RX buffers 240 are omitted.

Front-end 222d further includes switches 250c in place of switches 250a in FIG. 4. Switches 456 and 458 in switches 250a are replaced with single-pole double-throw switch 460 in switches 250c. Switch 460 has its single pole coupled to signal splitter 448, its first throw coupled to the output of transmitter 260, and its second throw coupled to the input of receiver 270. In another exemplary design, TX/RX buffers 240 are used to (i) buffer a received test signal from test signal line segments 216a and 216b and (ii) drive a test signal on test signal line segments 216a and 216b.

The exemplary design shown in FIG. 7B may provide a more symmetrical feed of a test signal. The test signal may observe less insertion loss due to propagation via shorter test signal line segments 216a and 216b (as compared to test signal line 216 in FIG. 4). The exemplary design in FIG. 7B may also avoid or mitigate undesired coupling and may simplify chip layout and package layout.

FIG. 7C shows a schematic diagram of a front-end 222e, which is yet another exemplary design of front-end 222 of transceiver 220 in FIG. 3. Front-end 222e includes all of the circuits in front-end 222a in FIG. 4 with the following differences. In FIG. 7C, TX/RX buffers 240 are replaced with an attenuator (Atten) 242 to attenuate a higher power signal from a TX chain. Test signal line 216 has a first end coupled to a first I/O pin 710 of an IC chip and a second end coupled to attenuator 242 via a second I/O pin 712 of the IC chip. Front-end 222e further includes switches 250d in place of switches 250a in FIG. 4. Switches 456 and 458 in FIG. 4 are replaced with SPDT switches 462, 464, 466 and 468 in FIG. 7C. Switch 462 has its single pole coupled to I/O pin 710 and its first throw coupled to a termination resistor 218a. Switch 464 has its single pole coupled to the output of transmitter 260, its first throw coupled to switch 452, and its second throw coupled to the second throw of switch 462. Switch 468 has its single pole coupled to attenuator 242 and its first throw coupled to a termination resistor 218b. Switch 466 has its single pole coupled to the input of receiver 270, its first throw coupled to switch 454, and its second throw coupled to the second throw of switch 468.

Front-end 222e may operate in the normal operating mode or the test/calibration mode at any given moment. In the normal operating mode, switch 464 is connected to the first throw, and switch 466 is also connected to the first throw. An output RF signal from transmitter 260 may be routed through switches 450, 452 and 464 and provided to a selected front-end circuit 230. An input RF signal from a selected front-end circuit 230 may be routed through switches 450, 454 and 466 and provided to receiver 270. The test/calibration mode may include (i) the TX BIST configuration to test TX circuits within transceiver 220 and (ii) the RX BIST configuration to test RX circuits within transceiver 220. In the TX BIST configuration, switches 462 and 464 are each connected to the first throw, and switches 466 and 468 are each connected to the second throw. A test signal from transmitter 260 may be routed through switches 450, 452 and 464, provided to a selected front-end circuit 230, transmitted via associated antenna element 212, electro-magnetically coupled to test signal line 216, passed through attenuator 242, routed through switches 466 and 468, and provided to receiver 270. In the RX BIST configuration, switches 462 and 464 are each connected to the second throw, and switches 466 are each connected to the first throw. A test signal from transmitter 260 may be routed through switches 462 and 464, provided on test signal line 216, electro-magnetically coupled to antenna feed lines 214, conditioned by a selected front-end circuit 230, routed through switches 450, 454 and 466, and provided to receiver 270.

FIGS. 4, 6C, 7A, 7B and 7C show five exemplary designs of a front-end supporting BIST. A front-end supporting BIST may also be implemented in other manners. For example, a front-end may include only TX buffer 444 or only RX buffer 446.

In an exemplary design, an apparatus (e.g., a wireless device, an IC, a circuit module, a circuit board, etc.) may include a first circuit and a second circuit. The first circuit may provide a test signal to at least one transmit path. The test signal may be electro-magnetically coupled from the output of the at least one transmit path to a test signal line. For example, the test signal may be provided from the at least one transmit path via at least one antenna feed line to at least one antenna element and may be electro-magnetically coupled from the at least one antenna feed line to the test signal line. The second circuit may process a received test signal from the test signal line.

In an exemplary design, the at least one transmit path (e.g., transmit paths 410 in FIG. 4) may include at least one PA (e.g., PA 424 within TX chains/RX chains 420 in one or more front-end circuits 230 in FIG. 4) operatively coupled to at least one antenna element (e.g., antenna elements 212 of one or more antenna arrays 210). The at least one PA may be directly coupled to the at least one antenna element. Alternatively, the at least one PA may be indirectly coupled to the at least one antenna element via at least one switch, duplexer, directional coupler, etc. The first circuit may provide a test signal for testing the at least one transmit path. The test signal may be amplified by the at least one PA, routed via at least one antenna feed line (e.g., antenna feed lines 214) for the at least one antenna element, and electro-magnetically coupled from the at least one antenna feed line to the test signal line (e.g., test signal line 216). The test signal line may be electro-magnetically coupled to the at least one antenna feed line.

In an exemplary design, each PA may be part of a TX chain (e.g., TX chain 421). Each PA may amplify an output RF signal in a first mode (e.g., a normal operating mode) or the test signal in a second mode (e.g., a test/calibration mode).

The at least one transmit path may further include at least one phase shifter (e.g., phase shifter 428) coupled between the first circuit and the at least one PA. Each phase shifter may shift the phase of an output RF signal in the first mode or the test signal the second mode. Each TX chain may include a PA and a phase shifter, e.g., as shown in FIG. 4. The at least one transmit path may further include at least one signal splitter (e.g., signal splitters 430 and 431) coupled between the first circuit and the at least one PA.

The apparatus may further include at least one switch. For example, the apparatus may include (i) one or more switches (e.g., switches 450 and 452) coupled between the first circuit and the at least one PA and/or (ii) one or more switches (e.g., switches 456 and 458) coupled between the test signal line and a receiver (e.g., receiver 270).

In an exemplary design, the first circuit may comprise a transmitter (e.g., transmitter 260 in FIG. 5) that provides an output RF signal in the first mode or the test signal in the second mode. In another exemplary design, the first circuit may comprise at least one mixer (e.g., mixers 566a and 566b) that provides the output RF signal in the first mode or the test signal in the second mode. The first circuit may also comprise a test signal generator and/or other circuits.

In an exemplary design, the second circuit may comprise a buffer (e.g., RX buffer 446 in FIG. 4) coupled to the test signal line and configured to buffer the received test signal. In another exemplary design, the second circuit may comprise at least one mixer (e.g., mixers 572a and 572b) that downconverts an input RF signal in the first mode or the received test signal in the second mode. In yet another exemplary design, the second circuit may comprise a receiver (e.g., receiver 270 in FIG. 5) that processes the input RF signal in the first mode or the received test signal in the second mode. The second circuit may also comprise other circuits such as, e.g., a power detector.

In an exemplary design, each transmit path may be tested separately by passing the test signal to one transmit path at a time. This may enable each transmit path to be individually characterized.

In an exemplary design, the at least one transmit path may include a plurality of transmit paths coupled to a plurality of antenna elements. The plurality of transmit paths may be tested concurrently by passing the test signal to the plurality of transmit paths at the same time. Alternatively, each transmit path may be tested separately by passing the test signal to one transmit path at a time.

In another exemplary design, the at least one transmit path may include multiple sets of transmit paths coupled to multiple sets of antenna elements (e.g., antenna elements 212a to 212k in FIGS. 3 and 4) for multiple antenna arrays (e.g., antenna arrays 210a to 210k in FIG. 3). Each set of antenna elements may include a plurality of antenna elements configured as an antenna array. Each set of transmit paths may be tested separately by passing the test signal to one set of transmit paths at a time. The multiple sets of transmit paths may also be tested concurrently by passing the test signal to the multiple sets of transmit paths at the same time. Each transmit path may also be tested separately by passing the test signal to one transmit path at a time.

In an exemplary design, the apparatus may further include at least one receive path coupled to at least one additional antenna element. For TX-RX loop-back testing, the received test signal from the test signal line may be electro-magnetically coupled to at least one additional antenna feed line for the at least one additional antenna element and may be processed (e.g., amplified) by the at least one receive path. The second circuit may process the received test signal from the at least one receive path.

In an exemplary design, the test signal line may comprise a single segment and may be electro-magnetically coupled to antenna feed lines for all of the at least one antenna element, e.g., as shown in FIGS. 7A and 7C. In another exemplary design, the test signal line may comprise first and second segments. The first test signal line segment (e.g., test signal line segment 216a in FIG. 7C) may be electro-magnetically coupled to the output of a first set of transmit paths, e.g., to first antenna feed lines for a first plurality of antenna elements. The second test signal line segment (e.g., test signal line segment 216b) may be electro-magnetically coupled to the output of a second set of transmit paths, e.g., to second antenna feed lines for a second plurality of antenna elements.

In an exemplary design, the first circuit and the second circuit may be implemented on an IC chip. Some or all of the elements of the at least one transmit path may also be implemented on the IC chip. The test signal line may be implemented external to the IC chip. In an exemplary design, the test signal line may be terminated by a resistor (e.g., resistor 218 in FIG. 7A) external to the IC chip. In another exemplary design, the test signal line may be terminated by a resistor (e.g., resistor 218b in FIG. 7C) internal to the IC chip. In an exemplary design, the at least one antenna element may be implemented on a first metal layer, and the test signal line may be implemented on a second metal layer. The at least one antenna element and the test signal line may also be implemented in other manners.

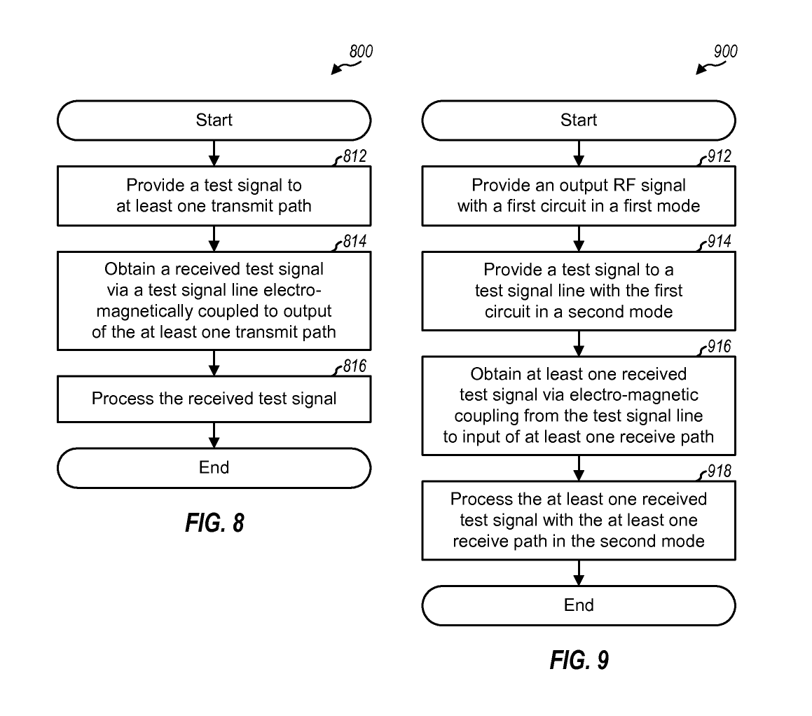

FIG. 8 shows an exemplary design of a process 800 for testing TX circuits with BIST. A test signal may be provided to at least one transmit path (block 812). A received test signal may be obtained via a test signal line (e.g., test signal line 216) electro-magnetically coupled to the output of the at least one transmit path (block 814). The received test signal may be processed with a second circuit (e.g., a buffer, a receiver, or a mixer) to test the at least one transmit path (block 816).

In an exemplary design, each of the at least one transmit path may be tested separately by passing the test signal to one transmit path at a time. In another exemplary design, the at least one transmit path may include multiple sets of transmit paths coupled to multiple sets of antenna elements for multiple antenna arrays. Each set of transmit paths for one antenna array may be tested separately by passing the test signal to one set of transmit paths at a time. Alternatively, multiple sets of transmit paths may be tested concurrently by passing the test signal to these multiple sets of transmit paths at the same time.

In another exemplary design, an apparatus (e.g., a wireless device, an IC, a circuit module, a circuit board, etc.) may comprise a first circuit and at least one receive path. The first circuit (e.g., transmitter 260 in FIG. 5) may provide an output RF signal in a first mode or a test signal to a test signal line (e.g., test signal line 216 in FIG. 4) in a second mode. The at least one receive path (e.g., receive paths 412 in FIG. 4) may receive the test signal electro-magnetically coupled from the test signal line to the input of the at least one receive path. For example, the test signal may be radiated by the test signal line and electro-magnetically coupled to at least one antenna feed line (e.g., antenna feed lines 214) between the at least one receive path and at least one antenna element (e.g., antenna elements 212). The at least one receive path may amplify at least one received test signal from the at least one antenna feed line in the second mode.

In an exemplary design, the at least one receive path may include at least one LNA (e.g., LNAs 426 in FIG. 4). Each LNA may amplify a received RF signal from one of the at least one antenna element in a first mode (e.g., a normal operating mode) or a received test signal in the second mode (e.g., a test/calibration mode).

The at least one receive path may further include at least one phase shifter (e.g., phase shifter 428 in FIG. 4) coupled between the at least one LNA and a receiver. Each phase shifter may shift the phase of a received RF signal in the first mode or a received test signal in the second mode. Each receive path may include an LNA and a phase shifter, e.g., as shown in FIG. 4. The at least one receive path may further include at least one signal combiner (e.g., signal combiners 430 and 431 in FIG. 4) coupled between the at least one LNA and the receiver. The at least one signal combiner may combine at least one signal from the at least one LNA. The apparatus may further include at least one switch (e.g., switches 450 and 452) coupled between the at least one LNA and the receiver.

FIG. 9 shows an exemplary design of a process 900 for testing RX circuits with BIST. An output RF signal may be provided by a first circuit (e.g., transmitter 260 in FIG. 3) in a first mode (e.g., a normal operating mode) (block 912). A test signal may be provided by the first circuit in a second mode (e.g., a test mode) (block 914). At least one received test signal may be obtained via electro-magnetic coupling from the test signal line to input of at least one receive path (block 916). The at least one received test signal may be processed by the at least one receive path in the second mode (block 918). The at least one received test signal may further be processed by a receiver (e.g., receiver 270) to test the at least one receive path.

The circuits in transmit paths, receive paths, transmitter, and/or receiver, the test signal line, and the antenna feed lines described herein may be implemented on an IC, an analog IC, an RFIC, a mixed-signal IC, an ASIC, a PCB, an electronic device, etc. The circuits may also be fabricated with various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing the circuits, test signal line, and/or antenna feed lines described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. An apparatus comprising:
a first circuit configured to provide a test signal to at least one transmit path, the test signal being electro-magnetically coupled from output of the at least one transmit path to a test signal line; and
a second circuit configured to process a received test signal from the test signal line.

2. The apparatus of claim 1, the test signal being provided from the at least one transmit path via at least one antenna feed line to at least one antenna element and being electro-magnetically coupled from the at least one antenna feed line to the test signal line.

3. The apparatus of claim 1, the at least one transmit path comprising:
at least one power amplifier (PA) configured to amplify the test signal.

4. The apparatus of claim 3, the at least one transmit path further comprising:
at least one phase shifter coupled between the first circuit and the at least one PA.

5. The apparatus of claim 3, the at least one transmit path further comprising:
at least one signal splitter coupled between the first circuit and the at least one PA.

6. The apparatus of claim 3, further comprising:
at least one switch coupled between the first circuit and the at least one PA.

7. The apparatus of claim 1, the first circuit comprising:
at least one mixer configured to provide an output radio frequency (RF) signal in a first mode and to provide the test signal in a second mode.

8. The apparatus of claim 1, the second circuit comprising:
a buffer coupled to the test signal line and configured to buffer the received test signal.

9. The apparatus of claim 1, the second circuit comprising:
at least one mixer configured to downconvert an input radio frequency (RF) signal in a first mode and to downconvert the received test signal in a second mode.

10. The apparatus of claim 1, each of the at least one transmit path being tested separately by passing the test signal to one transmit path at a time.

11. The apparatus of claim 1, the at least one transmit path comprising a plurality of transmit paths coupled to a plurality of antenna elements, the plurality of transmit paths being tested concurrently by providing the test signal to the plurality of transmit paths.

12. The apparatus of claim 1, the at least one transmit path comprising multiple sets of transmit paths coupled to multiple sets of antenna elements for multiple antenna arrays.

13. The apparatus of claim 12, each of the multiple sets of transmit paths being tested separately by providing the test signal to one set of transmit paths at a time.

14. The apparatus of claim 12, the multiple sets of transmit paths being tested concurrently by providing the test signal to the multiple sets of transmit paths.

15. The apparatus of claim 2, the received test signal from the test signal line being electro-magnetically coupled to at least one additional antenna feed line between at least one additional antenna element and at least one receive path, and the second circuit configured to process the received test signal from the at least one receive path.

16. The apparatus of claim 1, the at least one transmit path comprising first and second sets of transmit paths, the test signal line comprising:
a first test signal line segment electro-magnetically coupled to output of the first set of transmit paths, and
a second test signal line segment electro-magnetically coupled to output of the second set of transmit paths.

17. The apparatus of claim 1, the first circuit and the second circuit being implemented on an integrated circuit (IC) chip, and the test signal line being implemented external to the IC chip.

18. A method comprising:
providing a test signal to at least one transmit path;
obtaining a received test signal via a test signal line electro-magnetically coupled to output of the at least one transmit path; and
processing the received test signal.

19. The method of claim 18, further comprising:
testing each of the at least one transmit path separately by passing the test signal to one transmit path at a time.

20. The method of claim 18, the at least one transmit path comprising multiple sets of transmit paths coupled to multiple sets of antenna elements for multiple antenna arrays, the method further comprising:
testing each of the multiple sets of transmit paths separately by passing the test signal to one set of transmit paths at a time.

21. An apparatus comprising:
means for providing a test signal to at least one transmit path;
means for obtaining a received test signal via a test signal line electro-magnetically coupled to output of the at least one transmit path; and
means for processing the received test signal.

22. An apparatus comprising:
a first circuit configured to provide an output radio frequency (RF) signal in a first mode and to provide a test signal to a test signal line in a second mode; and
at least one receive path configured to receive the test signal electro-magnetically coupled from the test signal line to input of the at least one receive path.

23. The apparatus of claim 22, the at least one receive path comprising:
at least one low noise amplifier (LNA) configured to amplify at least one received test signal in the second mode.

24. The apparatus of claim 23, the at least one receive path further comprising:
at least one phase shifter coupled between the at least one LNA and a receiver and configured to shift a phase of at least one received RF signal in the first mode or the at least one received test signal in the second mode.

25. The apparatus of claim 23, the at least one receive path further comprising:
at least one signal combiner coupled between the at least one LNA and a receiver and configured to combine at least one received RF signal from the at least one LNA.

26. A method comprising:
providing an output radio frequency (RF) signal with a first circuit in a first mode;
providing a test signal to a test signal line with the first circuit in a second mode;
obtaining at least one received test signal via electro-magnetic coupling from the test signal line to input of at least one receive path; and
processing the at least one received test signal with the at least one receive path in the second mode.
